(19) United States
(12) Patent Application Publication
(10) Pub. No.: US 2024/0248769 A1
(43) Pub. Date: Jul. 25, 2024

(54) CROSS-CLOUD WORKLOAD PORTABILITY ACROSS CLOUD PROVIDERS

(71) Applicant: VMware, Inc., Palo Alto, CA (US)

(72) Inventor: Fernando Escobar, Miami, FL (US)

(21) Appl. No.: 18/099,653

(22) Filed: Jan. 20, 2023

(51) Int. Cl. G06F 9/50; G06Q 30/0645

(52) U.S. Cl. CPC G06F 9/5077; G06Q 30/0645; G06F 2209/503; G06Q 2220/12

(57) ABSTRACT

The present disclosure relates to moving workloads between cloud providers. A traceability application can receive a request to register a workload from a first virtualization service associated with a first cloud computing environment. To register the workload, the traceability application can generate an identification token in a distributed data store and an asset record corresponding to the identification token. The identification token can uniquely identify the workload among a plurality of workloads associated with a plurality of cloud computing environments. The traceability application can detect a migration of the VM from the first virtualization service associated with the first cloud computing environment to a second virtualization service associated with the second cloud computing environment. The traceability application can cause a transfer of an ownership of the identification token from the first virtualization service to the second virtualization service. The traceability application can update the asset record to reflect the transfer of the ownership of the identification token from the first virtualization service to the second virtualization service.

### BACKGROUND

As networking technology has developed, computing has increasingly shifted from computing done using local computing devices to on-demand delivery of computing services over the Internet. These computing services may be provided by cloud providers that manage and operate vast collections of servers, databases, and other computing resources located in multiple data centers distributed over diverse geographical locations. Often, the computing resources of a single cloud provider have the capacity to provide data storage and computing power to multitudes of users at once.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 shows an example of a network environment, according to various embodiments of the present disclosure.

FIG. 2 shows a sequence diagram that provides one example of the operation of portions of the network environment, according to various embodiments of the present disclosure.

FIG. 3 shows an example of a flowchart that illustrates functionalities performed by components of the network environment.

FIG. 4 shows an example of a flowchart that illustrates functionalities performed by components of the network environment.

### DETAILED DESCRIPTION

The present disclosure relates to moving workloads between cloud providers. While cloud providers may provide cloud computing services to many different users at a time, the vastness of the computing resources operated by these cloud providers can result in excess computing capacity that would remain unused. At the same time, other cloud providers may require greater computing capacity than is available at a particular time. To mitigate both issues, a cloud provider with excess computing capacity can enter into at transaction to provide this excess computing capacity to a cloud provider needing additional computing capacity in exchange for some form of compensation.

Yet facilitating transactions like these can introduce new problems. For one, it may be difficult for a cloud provider with excess computing capacity to identify a cloud provider needing greater computing capacity, and vice-versa. And if a cloud provider with excess capacity does enter into a significant number these transactions, it may be difficult for that cloud provider to keep track of what other parties are using that computing capacity at a given time, especially if such a party later rents that excess computing capacity to still other cloud providers.

Various embodiments of the present disclosure provide solutions for moving computing workloads between cloud providers. The present disclosure provides a capacity exchange where a cloud provider can create a listing of one or more excess computing workloads, which can allow other cloud providers to easily initiate transactions to acquire these workloads and thereby satisfy a need for additional computing capacity. The present disclosure also provides a traceability application that can register various cloud providers' workloads and track the location of those workloads as they are migrated to other cloud providers.

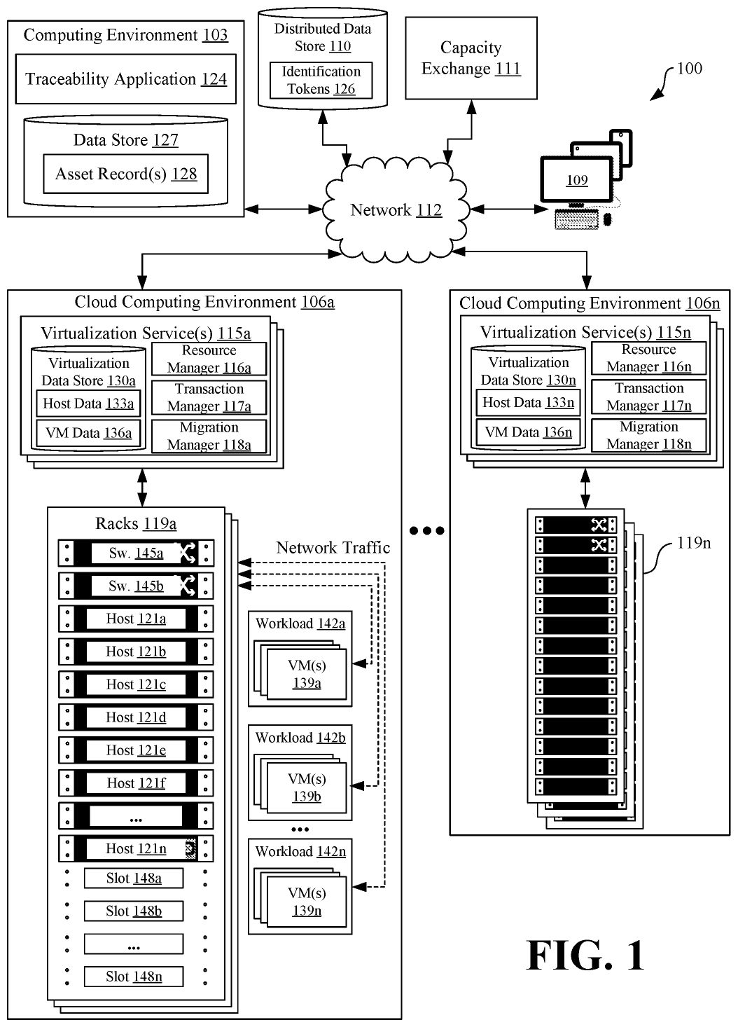

FIG. 1 shows an example of a network environment. The network environment 100 can include a computing environment 103, various cloud computing environments 106 (e.g., 106a, . . . , 106n), one or more client devices 109, a distributed data store 110, and a capacity exchange 111 in communication with one another over a network 112.

The network 112 can include wide area networks (WANs) and local area networks (LANs). These networks can include wired or wireless components, or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, Long Term Evolution (LTE) networks, as well as other networks relying on radio broadcasts. The network 112 can also include a combination of two or more networks 112. Examples of networks 112 can include the Internet, intranets, extranets, virtual private networks (VPNs), and similar networks. As the network environment 100 can serve up virtual desktops to end users, the network environment 100 can also be described as a virtual desktop infrastructure (VDI) environment.

The computing environment 103 can be embodied as one or more computers, computing devices, or computing systems. In certain embodiments, the computing environment 103 can include one or more computing devices arranged, for example, in one or more servers or computer banks. The computing device or devices can be located at a single installation site or distributed among different geographical locations. The computing environment 103 can include a plurality of computing devices that together embody a hosted computing resource, a grid computing resource, or other distributed computing arrangement. In some cases, the computing environment 103 can be embodied as an elastic computing resource where an allotted capacity of processing, network, storage, or other computing-related resources vary over time. As further described below, the computing environment 103 can also be embodied, in part, as certain functional or logical (e.g., computer-readable instruction) elements or modules as described herein.

Various applications can be executed on the computing environment 103. For example, a traceability application 124 can be executed by the computing environment 103. Other applications, services, processes, systems, engines, or functionality not discussed in detail herein may also be executed or implemented by the computing environment 103.

The computing environment 103 can further include a data store 127. The data store 127 can include memory of the computing environment 103, mass storage resources of the computing environment 103, or any other storage resources on which data can be stored by the computing environment 103. In some examples, the data store 127 can include one or more relational databases, object-oriented databases, hierarchical databases, hash tables or similar key-value data stores, as well as other data storage applications or data structures. The data stored in the data store 127, for example, can be associated with the operation of the various services or functional entities described below. For example, asset record(s) 128 and/or other data can be stored in the data store 127.

The traceability application 124 can be executed to register and track the location of workloads 142 managed by virtualization services 115 associated with the various cloud computing environments 106. The traceability application 124 can handle registration of workloads 142 on behalf of a virtualization service 115. For example, the traceability application 124 can receive a request to register a newly assigned workload 142 from the associated virtualization service 115. In some implementations, this registration request can comprise an identifier associated with the new workload 142 and an identifier associated with the requesting virtualization service 115.

In some implementations, the identifier associated with the new workload 142 can be unique among virtual machines 139 managed by the requesting virtualization service 115, but it may not be unique among identifiers of virtual machines 139 managed by other virtualization services 115 and/or associated with other cloud computing environments 106. The identifier associated with the requesting virtualization service 115, however, can be unique among the virtualization services 115 executing in the various cloud computing environments 106 in some implementations.

Upon receiving the request, the traceability application 124 can generate an identification token 126 for the workload 142 and issue that identification token 126 to the requesting virtualization service 115. The traceability application 124 can generate the identification token 126 using the identifiers received with the registration request. This identification token 126 can globally and uniquely identify the new workload 142 among all workloads 142 registered with the traceability application 124—which could potentially include any workload 142 operated by the various cloud computing environments 106. The identification token 126 can include, for example, a non-fungible token (NFT). To generate the identification token 126, the traceability application 124 can invoke a function, interface, or other mechanism provided by the distributed data store 110 to generate the identification token 126 in the distributed data store 110.

The traceability application 124 can create an asset record 128 for the identification token 126. The traceability application 124 can include an identifier for the virtualization service 115 that manages the workload 142 in the asset record 128. The traceability application 124 can also include various attributes associated with the identification token 126, as discussed below. The traceability application 124 can then provide confirmation of the registration of the workload 142 and the creation of the identification token 126 to the requesting virtualization service 115.

The identification token 126 can allow the traceability application 124 to track the location of the corresponding workload 142 globally. That is, the traceability application 124 can track that workload 142 even if it is migrated to another virtualization service 115 or another cloud computing environment 106.

The traceability application 124 can detect a migration of a workload 142 from an origin entity to a destination entity. For example, the traceability application 124 can be notified by the origin entity that the workload 142 is migrating to the destination entity. As another example, the traceability application 124 can be notified of the migration by destination entity. Each of the origin entity and the destination entity could be any two hosts 121 within same or different cloud computing environments 106 within the network environment. The notification can include an identifier for the destination entity, an identifier for the source entity, and/or other information regarding the workload 142 or the transaction. The identifier for the source entity can include an identifier for the virtualization service 115 that currently manages the workload 142, the cloud computing environment 106 within which the workload 142 is currently executing, or both. Likewise, the identifier for the destination entity can include an identifier for the virtualization service 115 that will manage the workload 142 after migration, the cloud computing environment 106 to which the workload 142 will migrate, or both.

When a workload 142 is migrated, the traceability application 124 can transfer ownership of the corresponding identification token 126 to the destination entity. For example, the traceability application 124 can invoke a method or function provided by the identification token 126, such as a smart contract, to cause ownership of the identification token 126 to be transferred. In some implementations, the traceability application 124 can include an identifier associated with the destination entity as an argument to the method or function. The traceability application 124 can thereby cause the distributed data store 110 to be updated to reflect the transfer of ownership. The traceability application 124 can notify the source entity and the destination entity of the transfer before, after, or concurrently with the updating of the assert record 128 discussed below.

In some implementations, however, the traceability application 124 can limit or condition the transfer of ownership of an identification token 126 to enforce compliance with governmental or other regulations that are relevant to the transfer of ownership, the source entity, and/or the destination entity. Such regulations can include, for example, data privacy laws or industry-specific regulations such as Health Insurance Portability and Accountability Act (HIPAA) regulations, payment card industry (PCI) compliance, and others. The traceability application 124 can therefore deny or otherwise limit a transfer of ownership that is not compliant with any applicable regulations. Likewise, the traceability application 124 can approve a transfer of ownership that is compliant with applicable regulations.

The traceability application 124 can record the migration of a workload 142. The traceability application 124 can record the migration by, for example, generating or updating the asset record 128 for the identification token 126 associated with the migrating workload 142. The traceability application 124 can update the asset record 128 to include an identifier for the new virtualization service 124 and/or the new cloud computing environment 106. In some implementations, the traceability application 124 can invoke a function provided by a smart contract to execute the transfer of ownership and/or update the asset record 128.

The traceability application 124 can provide information regarding a particular workload 142 to a client device 109 upon request. Such information can, in various implementations, include any information in an asset record 128 for that workload 142, which is discussed in detail below. For instance, a client device 109 affiliated with a particular cloud computing environment 106 can request a current location of a workload 142 that was migrated from that cloud computing environment 106. Upon receiving a request, the traceability application 124 can retrieve this information from the asset records 128. In some implementations, the traceability application 124 can invoke a function provided by a smart contract to retrieve this information. The traceability application 124 can then provide this information to the requesting client device 109.

The asset record(s) 128 represent data associated with individual identification tokens 126 generated by the traceability application 124. Each asset record 128 can record transfers in ownership of a corresponding identification token 126, thereby allowing the traceability application 124 to track migration of the workload 142 represented by the identification token 126. An asset record 128 can include one or more attributes of its corresponding identification token 126. For example, the asset record 128 can include one or more identifiers for a current owner of the identification token 126, which can represent a current location of an associated workload 142. That is, the asset record 128 can include an identifier for a virtualization service 115 that manages the workload 142 and/or an identifier for a cloud computing environment 106 associated with the virtualization service 115. The asset record 128 can further include an internet protocol (IP) address of the managing virtualization service 115, an associated domain name service (DNS), and other information that enables the traceability application 124 to track the corresponding workload 142. In some implementations, the asset record 128 can further include the above information for previous owners of the identification token 126.

The cloud computing environments 106 (e.g., cloud computing environments 106a, . . . , 106n) can represent various enterprise computing environments. A cloud computing environment 106 can be associated with one of various cloud providers, and any one of the various cloud providers can operate one or more cloud computing environments 106. Each cloud computing environment 106 can include hundreds or even thousands of physical machines, VMs, and other software implemented in devices stored in racks 119, distributed geographically across locations or sites that include clusters of computing devices connected to one another through the network 112. A virtual machine (VM) 139 or virtual appliance can be implemented using at least one physical device.

In addition, although the term “cloud computing environment 106” is used, the principled disclosed with respect to the cloud computing environment 106 may also be applicable to on-premises (hybrid) virtualization. This can include, for example, solely on-premises virtualization or on-premises virtualization in combination with one or more cloud providers.

The cloud computing environment 106 can include, for example, a server or any other system providing computing capability. Alternatively, the cloud computing environment 106 can include one or more computing devices that are arranged, for example, in one or more server banks, computer banks, computing clusters, or other arrangements. The cloud computing environment 106 can include a grid computing resource or any other distributed computing arrangement. The computing devices can be located in a single installation or can be distributed among many different geographical locations.

Various applications can be executed on the cloud computing environment 106. For example, a virtualization service 115 can be executed by the cloud computing environment 106. Other applications, services, processes, systems, engines, or functionality not discussed in detail herein may also be executed or implemented by the cloud computing environment 106. The cloud computing environment 106 can include or be operated as one or more virtualized computer instances.

For purposes of convenience, the cloud computing environment 106 is sometimes referred to herein in the singular. Even though the cloud computing environment 106 is referred to in the singular, it is understood that a plurality of cloud computing environments 106a-n can be employed in the various arrangements as described above. As the cloud computing environment 106 communicates with the computing environment 103 and client devices 109 for end users over the network 112, sometimes remotely, the cloud computing environment 106 can be described as a remote cloud computing environment 106 in some examples. Additionally, in some examples, the cloud computing environment 106 can be implemented in hosts 121 (e.g., 121a . . . 121n) of a rack 119 and can manage operations of the virtualized cloud computing environment 106.

In various examples, the virtualization service 115 can include a computer program that resides and executes in a central server, which may reside in the computing environment 103, and can run in a VM 139 (e.g., 139a . . . 139c) in one of hosts 121. One example of a virtualization management module or virtualization service is the vCenter Server® product made available from VMware, Inc. The virtualization service 115 can be configured to carry out administrative tasks for a virtualized environment, including managing hosts 121, managing workloads 142 (e.g., 142a, . . . , 142n), managing VMs 139 running within each host 121, provisioning VMs 139, migrating VMs 139 from one host 121 to another host 121, migrating VMs 139 from one cloud computing environment 106 to another cloud computing environment 106, and load balancing between the hosts 121. In some examples, the virtualization service 115 can manage and integrate virtual computing resources provided by a third-party cloud computing system with virtual computing resources of virtualization service 115 to form a unified “hybrid” computing platform.

When the virtualization service 115 assigns a new workload 142 (or, in some implementations, instantiates a new VM 139 within a workload 142), the virtualization service 115 can request registration of the new workload 142 with the traceability application 124. This registration request can comprise, for example, an identifier associated with the new workload 142 and an identifier associated with the virtualization service 115. The identifier for the new workload 142 can be generated upon creation of the new workload 142. This identifier can be internal to the virtualization service 115, meaning that the identifier may not be unique among identifiers of workloads 142 managed by other virtualization services 115. The virtualization service 115 can subsequently receive confirmation of the registration from the traceability application 124. The virtualization service 115 can include a resource manager 116, a transaction manager 117, a migration manager 118, and/or other applications.

The resource manager 116 can be executed to allocate workloads 142 (e.g., 142a . . . 139n) to one or more hosts 121 based on various factors. For example, the resource manager 116 can add an extra host 121 to the set of hosts 121 assigned to a workload 142 in response to an increase in demand for computing resources. As another example, the resource manager 116 can reassign workloads 142 or VMs 139 within a workload 142 from one host 121 to another host 121 in order to more effectively use the hosts 121 assigned to the workload 142. For instance, if a first host 121 is scheduled for an upgrade, the resource manager 116 can reassign the VMs 139 executing on the first host 121 to a second host 121 based on various factors that can be used to identify the second host 121 as the best candidate host 121 among other hosts 121 in the data center. The resource manager 116 can include a number of modules and components that work in concert for management of the hosts 121 and workloads 142. For example, the resource manager 116 can include VSphere™ High Availability (HA), VMware Distributed Resource Scheduler (DRS), VMware VCenter™ Server, and other VMware VSphere™ components. The various components of the resource manager 116 can work in concert to achieve the functionalities described for the resource manager 116.

The resource manager 116 can manage excess computing capacity in the hosts 121. For example, resource manager 116 could determine that the total computing capacity of the hosts 121 is greater than the computing capacity used by current (and predicted) workloads 142a-n performed by the hosts 121. In that case, the resource manager 116 can calculate that excess capacity using the various modules and components discussed above. The resource manager 116 can identify a workload 142 for migration automatically based on resource usage of the various hosts 121 and a load balancing algorithm, or manually in response to a user request to migrate the workload 142.

The transaction manager 117 can be executed to manage transactions involving excess computing capacity identified by the resource manager 116. When the resource manager 116 identifies excess computing capacity in the hosts 121—or identifies a workload 142 in particular—the transaction manager 117 can interact with the capacity exchange 111 to identify a destination entity for the identified workload 142. In particular, the transaction manager 117 can cause a listing for the identified workload 142 to be created in the capacity exchange 111. This listing can identify the workload 142 for migration, a quantity of computing capacity represented by the workload 142 (as measured by the resource manager 116 using various performance metrics), proposed terms for the transaction such as desired compensation for exchanging the workload 142 with a destination entity, and other pertinent information.

The transaction manager 117 can periodically poll the capacity exchange 111 until a destination entity initiates a transaction. For example, a destination entity can interact with the listing to accept proposed transaction terms included in the listing. The transaction manager 117 can detect the destination entity's acceptance of the transaction terms when the transaction manager 117 subsequently polls the capacity exchange 111. In some implementations, however, the transaction manager 116 and destination entity can facilitate the transaction by interacting with each other directly, instead of interacting through the capacity exchange 111.

In some implementations, the transaction manager 117 can notify the traceability application 124 of the transaction once the transaction manager 117 detects that the destination entity has initiated the transaction. This notification can include an identifier for the destination entity, an identifier for the virtualization service 115 that currently manages the workload 142, an identifier for the cloud computing environment 106 within which the workload 142 is currently executing, and/or other information regarding the workload 142 or the transaction. In other implementations, the transaction manager 116 may omit this notification if the destination entity will instead provide a notification to the traceability application 124. In still other implementations, both the transaction manager 116 and the destination entity can provide notifications to the traceability application 124. In any case, the terms of the transactions can specify which of the parties will provide the notification.

The destination entity can represent a component of the various cloud computing environments 106a, . . . , 106n of the network environment 100. Suppose for the sake of example that the workload 142 is executed in a particular cloud computing environment 106a and managed by a virtualization service 115a within the cloud computing environment 106a. For example, the destination entity can include a host 121 or other destination within the cloud computing environment 106a that is managed by the same virtualization service 115a. As another example, the destination entity can include a host 121 or other destination within the cloud computing environment 106a that is managed by a different virtualization service 115b. As an additional example, the destination entity can include a host 121 or other destination within another cloud computing environment 106b altogether. In some implementations, the functionality provided by the transaction manager 117 may be omitted for a destination entity managed by the same virtualization service 115a and/or a destination within the same cloud computing environment 106a. In that case, the migration manager 118 can initiate migration of the workload 142 automatically upon identification of the workload 142 by the resource manager 116. Also in that case, the resource manager 116 itself can identify a destination for the workload 142 within the same cloud computing environment 106a.

The migration manager 118 can be executed to manage the migration of workloads 142 identified by the resource manager 116 to destination entities identified by the transaction manager 117. The migration manager 118 can initiate a migration of a workload 142 according to terms of a transaction facilitated by the transaction manager 117. For example, the migration manager 118 can identify a network address for the destination entity and cause the workload 142 to be migrated to that address.

The virtualization service 115 can include a virtualization data store 130. The virtualization data store 130 can include memory of the virtualization service 115, mass storage resources of the virtualization service 115, or any other storage resources on which data can be stored by the virtualization service 115. The virtualization data store 130 can include memory of the hosts 121 in some examples. In some examples, the virtualization data store 130 can include one or more relational databases, object-oriented databases, hierarchical databases, hash tables or similar key-value data stores, as well as other data storage applications or data structures. The data stored in the virtualization data store 130, for example, can be associated with the operation of the various services or functional entities described below. For example, host data 133, VM data 136, and/or other data can be stored in the virtualization data store 130.

The host data 133 can represent information about the hosts 121 that are managed by the virtualization service 115. For example, the host data 133 can include information such as the amount of memory installed on the host 121, the number and type of processors installed on the host 121, the number and type of GPUs installed on the host 121, the number and type of network connections installed on the host 121, and various other data. The host data 133 can also include a record of the workload(s) 142 (e.g., specific VMs 139) performed by particular host(s) 121.

VM data 136 can represent information about the VMs 139 that are executed by the hosts 121 within the virtualization service 115. VM data 136 can include allocated CPU, memory, and storage resources for the various VMs, network configuration for the VMs, or an operating system (OS) image for the VMs. VM data 136 can also include certificate data, encryption data, security credentials, or other data needed to configure and operate the VMs 139 within the virtualization service 115.

The cloud computing environments 106 can further include a plurality of devices installed in racks 119, which can make up a server bank, aggregate computing system, or a computer bank in a data center or another like facility. In some examples, the cloud computing environment 106 can include a high-availability computing cluster. A high-availability computing cluster can include a group of computing devices that act as a single system and provides a continuous uptime for workloads. The devices in the cloud computing environments 106 can include any number of physical machines that perform workloads that include, VMs, virtual appliances, OSs, drivers, hypervisors, scripts, and applications.

The devices in the racks 119 can include, for example, memory and storage devices, hosts 121a . . . 121n, switches 145a . . . 145n, and other devices. Hosts 121 can include graphics cards having one or more graphics processing units (GPUs) installed thereon, central processing units (CPUs), power supplies, and other components. The devices, such as hosts 121 and switches 145, can have dimensions suitable for quick installation in slots 148a . . . 148n on the racks 119. In various examples, the hosts 121 can include requisite physical hardware and software to create and manage a virtualization infrastructure. The physical hardware for a host 121 can include a CPU, graphics card (having one or more GPUs), data bus, memory, and other components. In some examples, the hosts 121 can include a pre-configured hyper-converged computing device where a hyper-converged computing device includes pre-tested, pre-configured, and pre-integrated storage, server and network components, including software, that are positioned in an enclosure installed in a slot 148 on a rack 119.

The various physical and virtual components of the cloud computing environments 106 can process workloads 142. Workloads 142 can represent individual VMs 139 and sets of VMs 139 executed on the hosts 121. The VMs 139 can embody or include various applications that are executed for an organization or enterprise. The VMs 139 can provide functionalities including applications, data, and network functions to the client devices 109.

In addition to a VM 139, a workload 142 can correspond to other components running on the host 121. These can include one or more containers of Kubernetes® pods, one or more vSAN® components, one or more data transport connections, one or more network functions, and other components. The various components can provide functionalities that can be accessed by various client devices 109 for enterprise purposes.

Workloads 142 can be executed on a host 121 that runs a hypervisor that facilitates access to the physical resources of the host device by the workloads 1425 running atop the hypervisor. In some examples, the hypervisor can be installed on a host 121 o to support a VM execution space wherein one or more VMs can be concurrently instantiated and executed. In some examples, the hypervisor can include the VMware ESX™ hypervisor, the VMware ESXi™ hypervisor, or similar hypervisor.

A hardware computer device such as a host 121 can execute an instance of one or more VMs 139. Each host 121 that acts as a host in the network environment 100, and thereby includes one or more VMs 139, can also include a hypervisor. In some examples, the hypervisor can be installed on a host 121 to support a VM execution space wherein one or more VMs 139 can be concurrently instantiated and executed. In some examples, the hypervisor can include the VMware ESX™ hypervisor, the VMware ESXi™ hypervisor, or similar hypervisor. The cloud computing environments 106 can be scalable, meaning that the cloud computing environments 106 in the network environment 100 can be scaled dynamically to include additional hosts 121, switches 145, power sources, and other components, without degrading performance of the virtualization environment. Further, various physical and virtual components of the cloud computing environments 106 can process workloads 142. Workloads 142 can refer to the amount of processing that a host 121, switch 145, GPU, or another physical or virtual component has been instructed to process or route at a given time. The workloads 142 can be associated with VMs 139 or other software executing on the hosts 121.

The client device(s) 109 can represent a computing device coupled to the network 112. The client device 109 can be a processor-based computer system. According to various examples, the client device 109 can be in the form of a desktop computer, a laptop computer, a personal digital assistant, a mobile phone, a smartphone, or a tablet computer system. The client device 109 can execute an OS, such as Windows™, Android™, or iOS®, and has a network interface to communicate with the network 112.

In some implementations, client device 109 can request information regarding a particular workload 142 from the traceability application 124. For example, the client device 109 can request information regarding a workload 142 that was originally created in a cloud computing environment 106 with which the client device 109 is affiliated. Such information can, in various implementations, include any information in an asset record 128 for that workload 142, which is discussed in detail above. For instance, the client device 109 can request a current location of a workload 142 that was migrated from the client device's 109 affiliated cloud computing environment 106. The client device 109 can receive this information from the traceability application 124 and display the information to a user of the client device 109 in a user interface.

The distributed data store 110 represents a synchronized, eventually consistent, data store spread across multiple nodes in different geographic or network locations. Each node in the distributed data store 110 can contain a replicated copy of the distributed data store 110, including all data stored in the distributed data store 110. Records of transactions involving the distributed data store 110 can be shared or replicated using a peer-to-peer network connecting the individual nodes that form the distributed data store 110. Once a transaction or record is recorded in the distributed data store 110, it can be replicated across the peer-to-peer network until the record is eventually recorded with all nodes. Various consensus methods can be used to ensure that data is written reliably to the distributed data store 110. In some implementations, data, once written to the distributed data store 110, is immutable. Examples of a distributed ledger can include various types of blockchains, distributed hash tables (DHTs), and similar data structures. Various data can be stored in a distributed ledger, such as one or more identification tokens 126.

An identification token 126 can globally and uniquely identify a workload 142 among all workloads 142 registered with the traceability application 124. This could potentially include any workload 142 operated by the various cloud computing environments 106. The identification token 126 can include, for example, a non-fungible token (NFT).

The capacity exchange 111 can represent one or more computing devices, computing resources, and/or applications or services that allow a source entity to list a workload 142 for exchange with a destination entity. The capacity exchange 111 can further allow a destination entity to interact with a listing to accept the source entity's proposed terms for a transaction to exchange the workload 142.

The capacity exchange 111 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the capacity exchange 111 can employ a plurality of computing devices that can be arranged in one or more server banks or computer banks or other arrangements. Such computing devices can be located in a single installation or can be distributed among many different geographical locations. For example, the capacity exchange 111 can include a plurality of computing devices that together can include a hosted computing resource, a grid computing resource or any other distributed computing arrangement. In some cases, the capacity exchange 111 can correspond to an elastic computing resource where the allotted capacity of processing, network, storage, or other computing-related resources can vary over time.

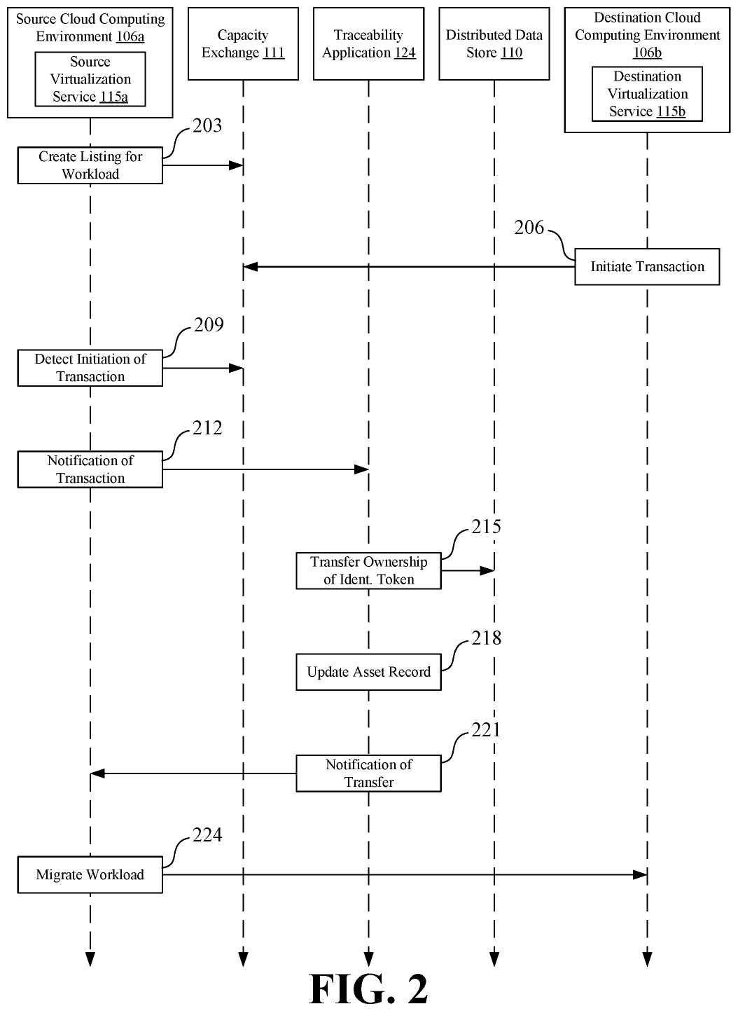

Referring next to FIG. 2, shown is a sequence diagram that provides one example of the operation of portions of the network environment 100. The sequence diagram of FIG. 2 provides merely an example of the many different types of functional arrangements that can be employed to implement the operation of the depicted portions of the network environment 100. As an alternative, the flowchart of FIG. 2 can be viewed as depicting an example of elements of a method implemented within the network environment 100.

Beginning with block 203, a source virtualization service 115a can create a listing for a workload 142 in the capacity exchange 111. The source virtualization service 115a can be executing in a source cloud computing environment 106a. The source virtualization service 115a can determine that the total computing capacity of hosts 121 associated with the source virtualization service 115a is greater than the computing capacity used by current (and predicted) workloads 142a-n performed by the hosts 121. The source virtualization service 115a can then identify the workload 142 for migration automatically based on resource usage of the various hosts 121 and a load balancing algorithm, for example. The source virtualization service 115a can then interact with the capacity exchange 111 to create the listing for the identified workload 142 in the capacity exchange 111. This listing can identify the workload 142 for migration, a quantity of computing capacity represented by the workload 142, a desired compensation for can exchange of the workload 142, and other pertinent information.

At block 206, a destination virtualization service 115b can initiate a transaction with the source virtualization service 115b. For example, the destination virtualization service 115b an interact with the listing to accept proposed transaction terms included in the listing. The destination virtualization service 115b can be executing in a destination cloud computing environment 106b that is different from the source cloud computing environment 106a.

At block 209, the source virtualization service 115a can detect the destination virtualization service's 115b initiation of a transaction to exchange the workload 142. For example, the source virtualization service 115a can poll the capacity exchange 111 to determine whether the listing has been accepted.

At block 212, the source virtualization service 115a can provide a notification of the transaction to the traceability application 124. This notification can include an identifier for the source virtualization service 115a, an identifier for source cloud computing environment 106a, an identifier for the destination virtualization service 115b, an identifier for the destination cloud computing environment 106b, and/or other information regarding the workload 142 or the transaction.

At block 215, the traceability application 124 can cause ownership of an identifier token associated with the workload 142 to be transferred from the source virtualization service 115a to the destination virtualization service 115b. The identification token 126 can globally and uniquely identify the workload 142 among all workloads 142 registered with the traceability application 124, including those executing in the destination cloud computing environment 106b. The traceability application 124 can invoke a method or function provided by the identification token 126, such as a smart contract, to cause ownership of the identification token 126 to be transferred. In some implementations, the traceability application 124 can include an identifier associated with the destination virtualization service 115a and/or the destination cloud computing environment 106b as an argument to the method or function. The traceability application 124 can thereby cause the distributed data store 110 to be updated to reflect the transfer of ownership.

At block 218, the traceability application 124 can update an asset record 128 for the identification token 126 to reflect the transfer of ownership. The traceability application 124 can update the asset record 128 to include an identifier associated with the destination virtualization service 115a and/or the destination cloud computing environment 106b. In some implementations, the traceability application 124 can invoke a function provided by a smart contract to execute the transfer of ownership and/or update the asset record 128.

At block 221, the traceability application 124 can provide a notification of the completed transfer of ownership to the source virtualization service 115a and the destination virtualization service 115b. The traceability application 124 can notify the source virtualization service 115a and the destination virtualization service 115b of the completed transfer before, after, or concurrently with the updating of the assert record 128

At block 224, the source virtualization service 115a can initiate a migration of the workload 142 to the destination virtualization service 115b. The source virtualization service 115a can initiate a migration of a workload 142 according to the terms of the transaction. For example, the source virtualization service 115a can identify a network address for the destination virtualization service 115b and cause the workload 142 to be migrated to that address.

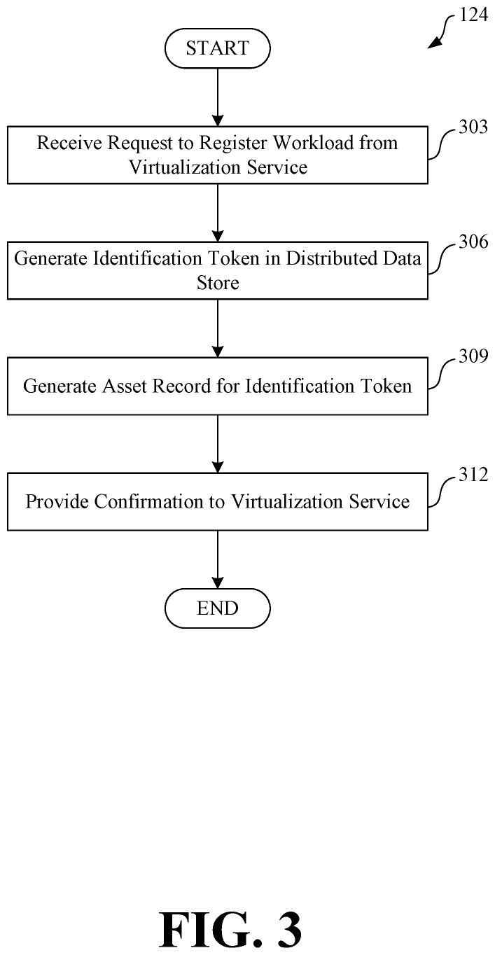

FIG. 3 includes a flowchart that illustrates functionalities performed by the traceability application 124. While the actions of the steps of FIG. 3 can be described as performed by a particular device or component, other components of the network environment 100 can also perform aspects of the steps and actions.

At block 303, the traceability application 124 can receive a request from a virtualization service 115 to register a workload 142 managed by the virtualization service 115. In some implementations, this workload 142 can be one that has been newly assigned or created by the virtualization service 115. The registration request can comprise, for example, an identifier associated with the workload 142 and an identifier associated with the virtualization service 115.

At block 306, the traceability application 124 can generate an identification token 126 for the workload 142 in the distributed data store 110. The traceability application 124 can generate the identification token 126 using the identifier associated with the workload 142 and the identifier associated with the virtualization service 115. This can allow the identification token 126 to globally and uniquely identify the new workload 142 among all workloads 142 registered with the traceability application 124. To generate the identification token 126, the traceability application 124 can, for instance, invoke a function, interface, or other mechanism provided by the distributed data store 110. This function, interface, or other mechanism can then cause the identification token 126 to be generated and stored in the distributed data store 110.

At block 309, the traceability application 124 can generate an asset record 128 for the identification token 126. The traceability application 124 can include the identifier for the virtualization service 115 in the asset record 128, which can reflect a current ownership of the identification token 126 and consequently a current location of the workload 142. The traceability application 124 can also include, for example, an internet protocol (IP) address of the virtualization service 115, an associated domain name service (DNS), and other information that enables the traceability application 124 to track the current location of the corresponding workload 142.

At block 312, the traceability application 124 can provide a confirmation of the workload's 142 registration to the virtualization service 115. This confirmation can likewise indicate that the identification token 126 has been generated and issued to the workload 142. Thereafter, the process can proceed to completion.

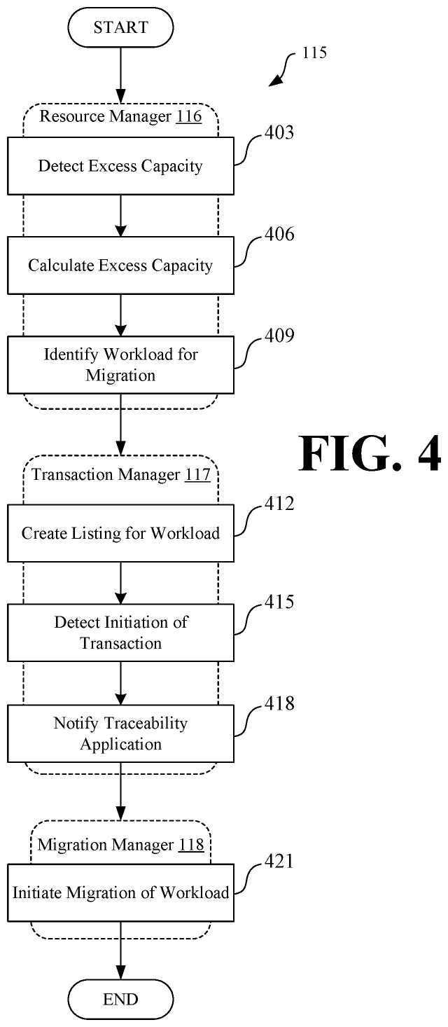

FIG. 4 includes a flowchart that illustrates functionalities performed by a virtualization service 115. While the actions of the steps of FIG. 4 can be described as performed by a particular device or component, other components of the network environment 100 can also perform aspects of the steps and actions.

To begin, blocks 403, 406, and 409 can be performed by a resource manager 116 of the virtualization service 115. At block 403, the resource manager 116 can detect excess computing capacity in hosts 121 associated with the resource manager 116. For example, resource manager 116 could determine that the total computing capacity of the hosts 121 is greater than the computing capacity used by current (and predicted) workloads 142a-n performed by the hosts 121. The resource manager 116 can make this determination based on a number of modules and components that work in concert for management of the hosts 121 and workloads 142.

At block 406, the resource manager 116 can calculate a quantity of the excess computing capacity detected at block 403. The resource manager 116 can calculate that excess capacity using the various modules and components discussed above. For example, the resource manager 116 can calculate a quantity of the excess capacity using VSphere™ High Availability (HA), VMware Distributed Resource Scheduler (DRS), VMware VCenter™ Server, and other VMware VSphere™ components.

At block 409, the resource manager 116 can identify a workload 142 for migration to a destination entity. The resource manager 116 can identify a workload 142 for migration automatically based on resource usage of the various hosts 121 and a load balancing algorithm, or manually in response to a user request to migrate the workload 142.

The process can then proceed to blocks 412, 415, and 418, which can be performed by a transaction manager 117 of the virtualization service 115. At block 412, the transaction manager 117 can create a listing for the workload 142 in the capacity exchange 111. This listing can identify the workload 142 for migration, a quantity of computing capacity represented by the workload 142 (as measured by the resource manager 116 using various performance metrics), proposed terms for the transaction such as desired compensation for exchanging the workload 142 with a destination entity, and other pertinent information.

At block 415, the transaction manager 117 can detect an initiation of a transaction involving an exchange of the workload 142 with a destination entity. The transaction manager 117 can periodically poll the capacity exchange 111 until a destination entity initiates a transaction. For example, a destination entity can interact with the listing to accept proposed transaction terms included in the listing. The transaction manager 117 can detect the destination entity's acceptance of the transaction terms when the transaction manager 117 subsequently polls the capacity exchange 111.

At block 418, the transaction manager 117 can notify the traceability application 124 of the transaction. This notification can include an identifier for the destination entity, an identifier for the virtualization service 115 that currently manages the workload 142, an identifier for the cloud computing environment 106 within which the workload 142 is currently executing, and/or other information regarding the workload 142 or the transaction.

The process can then move to block 421, where a migration manager 118 of the virtualization service can initiate a migration of the workload 142. The migration manager 118 can initiate a migration of a workload 142 according to terms of a transaction facilitated by the transaction manager 117. The migration manager 118 can identify a network address for the destination entity and cause the workload 142 to be migrated to that address.

Functionality attributed to the executable components discussed herein can be implemented in a single process or application or in multiple processes or applications. The separation or segmentation of functionality as discussed herein is presented for illustrative purposes only.

Flowcharts and sequence diagrams can show examples of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts and sequence diagrams can show a specific order of execution, it is understood that the order of execution can differ from that which is shown. For example, the order of execution of two or more elements can be switched relative to the order shown. Also, two or more elements shown in succession can be executed concurrently or with partial concurrence. Further, in some examples, one or more of the elements shown in the flowcharts can be skipped or omitted.

The computing devices and other hardware components described herein can include at least one processing circuit. Such a processing circuit can include, for example, one or more processors and one or more storage devices that are coupled to a local interface. The local interface can include, for example, a data bus with an accompanying address/control bus or any other suitable bus structure.

The one or more storage devices for a processing circuit can store data or components that are executable by the one or more processors of the processing circuit. For example, the various executable software components can be stored in one or more storage devices and be executable by one or more processors. Also, a data store can be stored in the one or more storage devices.

The functionalities described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more of the components described herein that include software or program instructions can be embodied in any non-transitory computer-readable medium for use by or in connection with an instruction execution system such as a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in at least one computing device or by using multiple computing devices.

As used herein, “about,” “approximately,” and the like, when used in connection with a numerical variable, can generally refer to the value of the variable and to all values of the variable that are within the experimental error (e.g., within the 95% confidence interval for the mean) or within +/−10% of the indicated value, whichever is greater.

Where a range of values is provided, it is understood that each intervening value and intervening range of values, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

Therefore, at least the following is claimed:

1. A system, comprising:
at least one computing device; and
machine-readable instructions executable in the at least one computing device that, when executed by the at least one computing device, cause the at least one computing device to at least:
receive a request to register a virtual machine (VM) from a first virtualization service associated with a first cloud computing environment;
generate a non-fungible token (NFT) that uniquely identifies the VM among a plurality of VMs associated with a plurality of cloud computing environments;
generate an asset record corresponding to the NFT;
detect a migration of the VM from the first virtualization service associated with the first cloud computing environment to a second virtualization service associated with a second cloud computing environment;
cause a transfer of an ownership of the NFT from the first virtualization service to the second virtualization service; and
update the asset record to reflect the transfer of the ownership of the NFT from the first virtualization service to the second virtualization service.

2. The system of claim 1, wherein the machine-readable instructions, when executed, further cause the at least one computing device to at least:
receive a request for a current location of the VM from a client device associated with the first cloud computing environment; and
provide, to the client device, an indication of a location of the VM with the second virtualization service associated with the second cloud computing environment.

3. The system of claim 1, wherein the request to register the VM comprises an identifier associated with the VM and an identifier associated with the first virtualization service.

4. The system of claim 3, wherein the NFT is generated based at least in part on the identifier associated with the VM and the identifier associated with the first virtualization service.

5. The system of claim 1, wherein the machine-readable instructions that cause the at least one computing device to cause the transfer of the ownership of the NFT from the first virtualization service to the second virtualization service further cause the at least one computing device to at least invoke a function provided by a distributed data store storing the NFT.

6. The system of claim 1, wherein the machine-readable instructions that cause the at least one computing device to generate the asset record corresponding to the NFT further cause the at least one computing device to at least generate the asset record to comprise an identifier associated with the first virtualization service, an identifier associated with the first cloud computing environment, and an internet protocol (IP) address of the first virtualization service.

7. The system of claim 6, wherein the machine-readable instructions that cause the at least one computing device to update the asset record to reflect the transfer of the ownership of the NFT from the first virtualization service to the second virtualization service further cause the at least one computing device to at least:
modify the asset record to comprise an identifier corresponding to the second virtualization service in place of the identifier corresponding to the first virtualization service; and
modify the asset record to comprise an identifier corresponding to the second cloud computing environment in place of the identifier corresponding to the first cloud computing environment.

8. A method, comprising:
receiving a request to register a virtual machine (VM) from a first virtualization service associated with a first cloud computing environment;
generating a non-fungible token (NFT) that uniquely identifies the VM among a plurality of VMs associated with a plurality of cloud computing environments;
generating an asset record corresponding to the NFT;
detecting a migration of the VM from the first virtualization service associated with the first cloud computing environment to a second virtualization service associated with the second cloud computing environment;
causing a transfer of an ownership of the NFT from the first virtualization service to the second virtualization service; and
updating the asset record to reflect the transfer of the ownership of the NFT from the first virtualization service to the second virtualization service.

9. The method of claim 8, further comprising:
receiving a request for a current location of the VM from a client device associated with the first cloud computing environment; and
providing, to the client device, an indication of a location of the VM with the second virtualization service associated with the second cloud computing environment.

10. The method of claim 8, wherein the request to register the VM comprises an identifier associated with the VM and an identifier associated with the first virtualization service.

11. The method of claim 10, wherein the NFT is generated based at least in part on the identifier associated with the VM and the identifier associated with the first virtualization service.

12. The method of claim 8, wherein causing the transfer of the ownership of the NFT from the first virtualization service to the second virtualization service further comprises invoking a function provided by a distributed data store storing the NFT.

13. The method of claim 8, wherein generating the asset record corresponding to the NFT further comprises generating the asset record to comprise an identifier associated with the first virtualization service, an identifier associated with the first cloud computing environment, and an internet protocol (IP) address of the first virtualization service.

14. The method of claim 13, wherein updating the asset record to reflect the transfer of the ownership of the NFT from the first virtualization service to the second virtualization service further comprises:
modifying the asset record to comprise an identifier corresponding to the second virtualization service in place of the identifier corresponding to the first virtualization service; and
modifying the asset record to comprise an identifier corresponding to the second cloud computing environment in place of the identifier corresponding to the first cloud computing environment.

15. A non-transitory computer-readable medium comprising program instructions stored in a memory of at least one computing device that, when executed by a processor of the at least one computing device, cause the at least one computing device to at least:
receive a request to register a virtual machine (VM) from a first virtualization service associated with a first cloud computing environment;
generate a non-fungible token (NFT) that uniquely identifies the VM among a plurality of VMs associated with a plurality of cloud computing environments;
generate an asset record corresponding to the NFT;
detect a migration of the VM from the first virtualization service associated with the first cloud computing environment to a second virtualization service associated with the second cloud computing environment;
cause a transfer of an ownership of the NFT from the first virtualization service to the second virtualization service; and
update the asset record to reflect the transfer of the ownership of the NFT from the first virtualization service to the second virtualization service.

16. The non-transitory computer-readable medium of claim 15, wherein the program instructions, when executed by the processor, further cause the at least one computing device to at least:
receive a request for a current location of the VM from a client device associated with the first cloud computing environment; and
provide, to the client device, an indication of a location of the VM with the second virtualization service associated with the second cloud computing environment.

17. The non-transitory computer-readable medium of claim 15, wherein the request to register the VM comprises an identifier associated with the VM and an identifier associated with the first virtualization service, and the NFT is generated based at least in part on the identifier associated with the VM and the identifier associated with the first virtualization service.

18. The non-transitory computer-readable medium of claim 15, wherein the machine-readable instructions that cause the at least one computing device to cause the transfer of the ownership of the NFT from the first virtualization service to the second virtualization service further cause the at least one computing device to at least invoke a function provided by a distributed data store storing the NFT.

19. The non-transitory computer-readable medium of claim 15, wherein the machine-readable instructions that cause the at least one computing device to generate the asset record corresponding to the NFT further cause the at least one computing device to at least generate the asset record to comprise an identifier associated with the first virtualization service, an identifier associated with the first cloud computing environment, and an internet protocol (IP) address of the first virtualization service.

20. The non-transitory computer-readable medium of claim 19, wherein the machine-readable instructions that cause the at least one computing device to update the asset record to reflect the transfer of the ownership of the NFT from the first virtualization service to the second virtualization service further cause the at least one computing device to at least:
modify the asset record to comprise an identifier corresponding to the second virtualization service in place of the identifier corresponding to the first virtualization service; and
modify the asset record to comprise an identifier corresponding to the second cloud computing environment in place of the identifier corresponding to the first cloud computing environment.
